(19) United States
(12) Patent Application Publication
(10) Pub. No.: US 2025/0313261 A1
(43) Pub. Date: Oct. 9, 2025

(54) STEER-BY-WIRE JACKET AXIS SKEWING ASSEMBLY

(71) Applicant: Steering Solutions IP Holding Corporation, Saginaw, MI (US)

(72) Inventors: Donald A. Buzzard, Saginaw, MI (US); Michael P. Anspaugh, Bay City, MI (US); Ryan D. Harris, Clio, MI (US)

(21) Appl. No.: 19/094,294

(22) Filed: Mar. 28, 2025

Related U.S. Application Data
(60) Provisional application No. 63/574,958, filed on Apr. 5, 2024.

(51) Int. Cl. B62D 5/00; B62D 1/185

(52) U.S. Cl. CPC B62D 5/006; B62D 1/185

(57) ABSTRACT

A vehicle steer-by-wire steering system includes a column jacket. The vehicle steer-by-wire steering system also includes a hand wheel actuator operatively coupled to an end of the column jacket, the hand wheel actuator disposed between an end of the column jacket and a steering input device, wherein at least a portion of the column jacket extends about a longitudinal axis which is oriented at a non-parallel angle relative to a central axis of the hand wheel actuator.

### CROSS-REFERENCE TO RELATED APPLICATIONS

This application claims the benefits of priority to U.S. Provisional Patent Application Ser. No. 63/574,958, filed Apr. 5, 2024, the disclosure of which is incorporated by reference herein in its entirety.

### FIELD OF THE INVENTION

The disclosure generally relates to vehicle steering systems and, more particularly, to a jacket axis skewing assembly for a steer-by-wire system.

### BACKGROUND

Traditional steering column designs have an upper shaft and a lower shaft which connect-via mechanical linkage-a steering wheel and road wheels. In such a configuration, several limitations with respect to collapse performance exist as it relates to functionality and costliness. Steer-by-wire systems eliminate the continuous mechanical connection between the steering wheel and the road wheels by having one or more hand wheel actuators and one or more road wheel actuators utilized to control steering of a vehicle.

During travel of the vehicle, the hand wheel actuator and road wheel actuator cooperate with each other, through electrical communication (e.g., wires, sensors, and a central processing unit), to directionally control travel of the vehicle. More specifically, sensed movement of the respective handwheel and/or tires is electrically communicated to the respective hand wheel actuator or road wheel actuator to cause movement of the handwheel and/or tires.

The steer-by-wire systems offer design simplifications and enhancements in some respects, when compared to steering columns requiring a continuous mechanical connection between the steering wheel and the road wheels.

### SUMMARY

According to one aspect of the disclosure, a vehicle steer-by-wire steering system includes a column jacket. The vehicle steer-by-wire steering system also includes a hand wheel actuator operatively coupled to an end of the column jacket, the hand wheel actuator disposed between an end of the column jacket and a steering input device, wherein at least a portion of the column jacket extends about a longitudinal axis which is oriented at a non-parallel angle relative to a central axis of the hand wheel actuator.

According to another aspect of the disclosure, a vehicle steer-by-wire steering system includes a column jacket. The vehicle steer-by-wire steering system also includes a hand wheel actuator operatively coupled to an end of the column jacket, the hand wheel actuator disposed between an end of the column jacket and a steering input device, wherein at least a portion of the column jacket extends about a longitudinal axis which is not co-axial with a central axis of the hand wheel actuator.

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features and advantages of the present disclosure are apparent from the following detailed description taken in conjunction with the accompanying drawings.

FIG. 1 generally illustrates a vehicle steer-by-wire system;

FIG. 2 is a side, elevation view of a portion of the steer-by-wire steering system;

FIG. 3 is a first perspective view of a portion of the steer-by-wire steering system;

FIG. 4 is a perspective view of a portion of the steer-by-wire steering system according to another aspect of the disclosure; and

FIG. 5 is a side, elevation view of a portion of the steer-by-wire steering system according to the embodiment of FIG. 4.

FIGS. 6 and 7 illustrate various steering column rake pivot locations provided by the steer-by-wire steering system.

### DETAILED DESCRIPTION

Referring now to the figures, where the present disclosure will be described with reference to specific embodiments, without limiting the same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

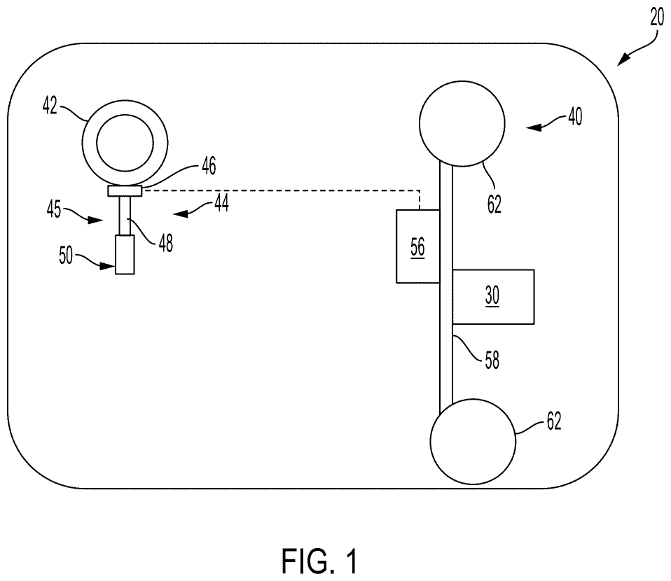

Referring initially to FIG. 1, a vehicle 20 is generally illustrated according to the principles of the present disclosure. The vehicle 20 may be any vehicle, such as a car, a truck, a sport utility vehicle, a mini-van, a crossover, any other passenger vehicle, any commercial vehicle, or any other suitable vehicle. While the vehicle 20 may be a passenger vehicle having wheels and for use on roads, the principles of the present disclosure may apply to other vehicles, such as planes, tractors, boats, or other suitable vehicles. The vehicle 20 may include a propulsion system 30, such as an internal combustion system, an electric system, or combinations thereof.

The vehicle 20 includes a steering system 40. The steering system 40 may be configured as a driver interface steering system, an autonomous driving system, or a system that allows for both driver interface and autonomous steering. The steering system includes a steering input device 42, such as a steering wheel, wherein a driver may manually provide a steering input by turning the steering wheel. A steering column assembly 44 includes a steering column 45 that extends along an axis. A hand wheel actuator (“HWA”) 46 (which may also be referred to as an “emulator”) is provided in the steer-by-wire system and is used to provide feedback and assistance to the steering input device 42 and to receive manual driver inputs for steering control.

The steering column 45 includes one or more portions, for example, an upper jacket 48 and a lower jacket 50. While two jackets are illustrated and described, it is to be appreciated that a single jacket or three or more jackets may be provided in some embodiments. Regardless of the number of jackets, the jackets may be axially and or height adjustable to be moveable over a range of positions to meet user preferences for positioning of the steering input device 42 and to provide energy absorption benefits during an impact event.

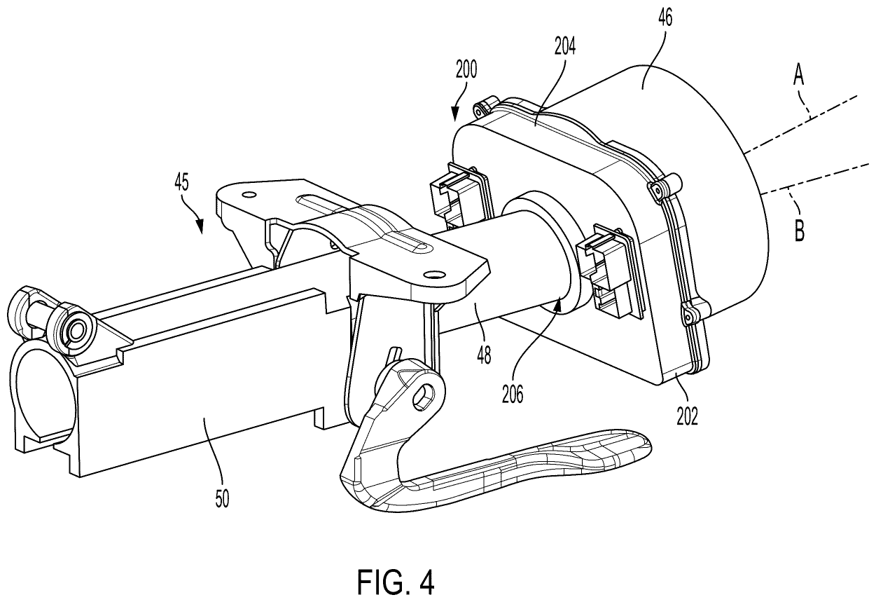

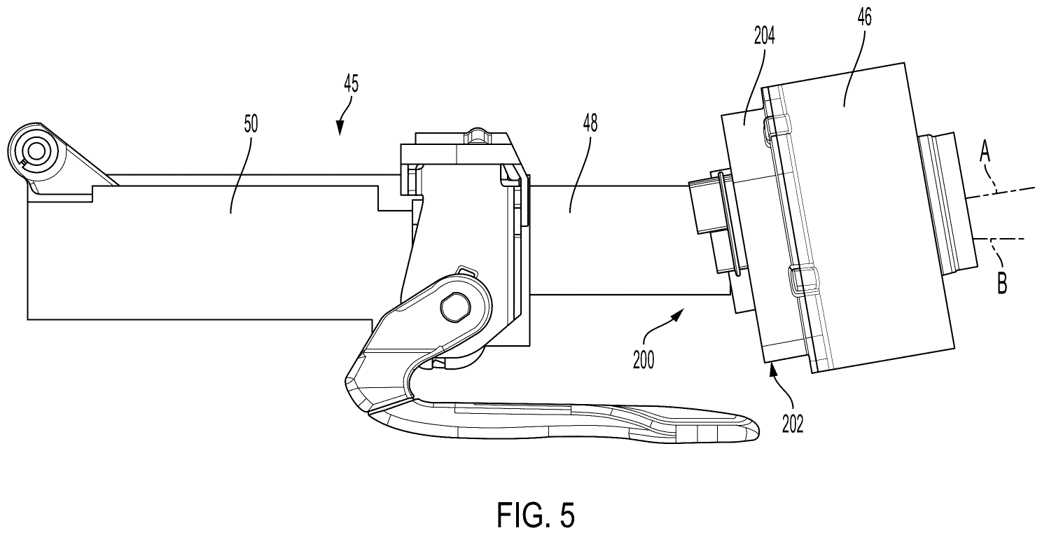

A road wheel actuator (“RWA”) 56 is in operative communication with the hand wheel actuator 46. The road wheel actuator 56 actuates lateral maneuvers of the vehicle in response to inputs received from the hand wheel actuator 46. Each of the hand wheel actuator 46 and the road wheel actuator 56 may include a respective processor and controller or a single processor may be in communication with a respective controller of each of the hand wheel actuator 46 (see e.g., FIGS. 4 and 5) and the road wheel actuator 56. The road wheel actuator 56 is part of a system which includes an output that drives a rack, ball screw or any other cross-car oriented component that is operatively coupled to the road wheels 62.

Historically, a continuous mechanical connection spanning multiple components was utilized to connect the steering wheel 42 to the vehicle road wheels 62. However, steer-by-wire systems have eliminated the need for an uninterrupted mechanical connection between the steering wheel 42 and the vehicle road wheels 62. For example, a steering shaft which couples to the steering wheel and one or more additional shafts (e.g., intermediate shaft) is no longer needed in some systems. Advancements such as those outlined above present new opportunities and challenges in steer-by-wire systems. For example, certain components may be moved away from traditional locations to new locations within the system.

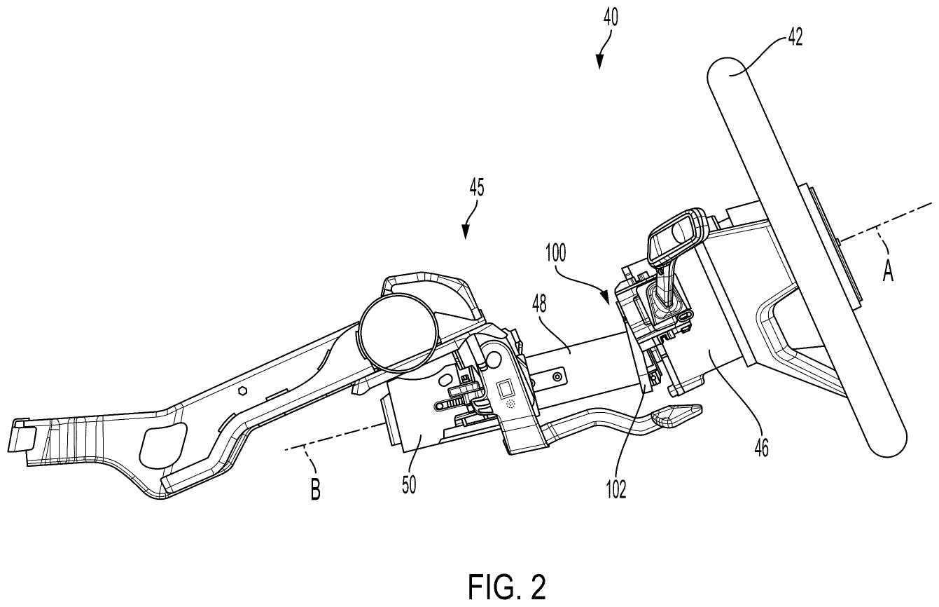

Referring now to FIG. 2, the steering system 40 is shown in more detail. The hand wheel actuator 46 is operatively coupled to a side of the steering wheel 42 distal from an operator. The hand wheel actuator 46 includes a motor disposed within a motor housing. A spindle or other type of output shaft is disposed within the motor and shares a common central axis with the motor. The steering wheel 42 is mounted to an end of the output shaft in embodiments with a rotatable shaft or a stationary spindle in other embodiments. In particular, the steering wheel 42 rotates with an output shaft in some embodiments, but other embodiments include a rotationally stationary spindle with another motor output component rotating with the steering wheel 42. An opposite end of the shaft or spindle is operatively coupled to the upper jacket 48 directly or via one or more intermediate components. The disclosed embodiments eliminate the need for at least some portions of a traditional steering shaft (e.g., intermediate shaft) and facilitates positioning of the hand wheel actuator 46 in close proximity to the steering wheel 42 for direct drive actuation thereof.

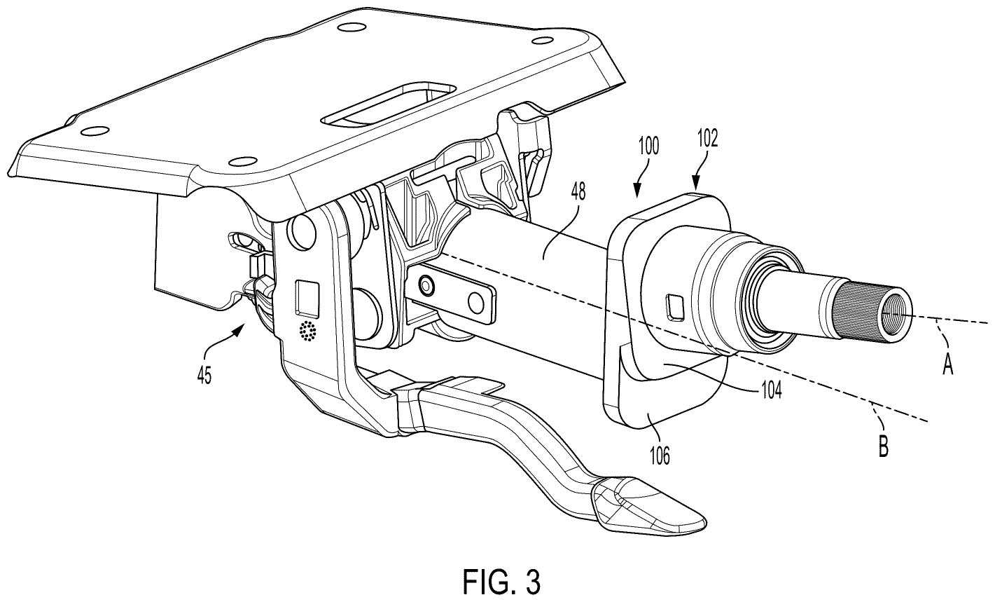

Referring now to FIGS. 2 and 3, a jacket axis skewing assembly 100 is shown and described herein. As described above, the embodiments disclosed herein include the handwheel actuator 46 positioned at the upper portion of the steering column, such as adjacent to, or in close proximity to, the hub of the steering wheel 42, for example. This actuator positioning—and the elimination of a straight, rigid steering shaft extending from the steering wheel 42 throughout the upper jacket 48 and any other jackets (e.g., lower jacket 50) which may be part of the steering column 45—facilitates the inclusion of an angular bend feature which allows the steer-by-wire steering system to maintain customer (i.e., OEM) handwheel plane specifications, while skewing all or a portion of the steering column 45 to an angle that achieves enhanced collapse performance benefits. In particular, a central axis A of the steering wheel 42 is oriented at an angle which maintains the handwheel orientation in a desired position for an operator, but all or a portion of the steering column jacket assembly extends about a longitudinal axis B which is oriented at a non-parallel angle relative to the central axis of the steering wheel 42. In other words, the steering wheel 42 is positioned about a first axis A which extends at a non-parallel angle relative to a second axis B defined by the longitudinal axis of all or a portion of the jacket(s) 48, 50 of the steering column 45.

The above-referenced collapse performance benefit is provided by the longitudinal axis B (i.e., second axis) of the jacket assembly 45 being closer to horizontal, when compared to the central axis A (i.e., first axis) of the steering wheel 42, which results in less friction between the jacket translation during collapse. Also the closer that axis B is to horizontal, the more balanced telescope in adjust effort will be in comparison to telescope out adjust effort. In a multi-jacket assembly, this is due to friction between the upper jacket 48 and the lower jacket 50—and possibly additional jackets-during collapse. As discussed above, it is contemplated that a single jacket 48 may be employed and this jacket may also experience friction with another component during collapse. Regardless of the number of jackets in the jacket assembly, friction is reduced by skewing the angle of the jacket assembly to be closer to horizontal when compared to the angle of the handwheel structure.

In the illustrated embodiment of FIGS. 2 and 3, the jacket axis skewing assembly 100 includes an adaptor 102 which is operatively coupled to the hand wheel actuator 46, or to an intermediate component therebetween. In some embodiments, the adaptor 102 is directly coupled to the motor housing of the hand wheel actuator 46, but in other embodiments, the adaptor 102 is operatively coupled to a controller housing or some other component disposed between the hand wheel actuator 46 and the adaptor 102.

As shown well in FIG. 3, the adaptor 102 is shaped to couple to the upper jacket 48 in a manner that offsets the angular orientation of the longitudinal axis B of the upper jacket 48 relative to the central axis A of the steering wheel 42 and the hand wheel actuator 46. This can be done with any contemplated geometry and shape of the adaptor to achieve the desired angular offset for a particular application. By way of non-limiting example in the illustrated embodiment of FIG. 3, the adaptor 48 includes a first portion 104 and a second portion 106. The first portion 104 includes a coupling structure that orients the spindle, or shaft, of the hand wheel actuator 46 at a first angle, while the second portion 106 includes a coupling structure that orients the upper jacket 48 at a second angle distinct from the first angle. In the illustrated embodiment, the first portion 104 is built upon the second portion 106 to protrude therefrom and to define an angular orientation which is different than the second portion 106. For example, the first portion 104 is a thickening of the adaptor 102 which extends toward the hand wheel actuator 46 away from the second portion 106.

Referring now to FIGS. 4 and 5, the jacket axis skewing assembly is shown according to another embodiment and is generally referenced with numeral 200. In the illustrated embodiment, the same principles related to offsetting the angular orientations of the upper jacket 48 and the hand wheel actuator—with the steering wheel 42—are adhered to. However, in the illustrated embodiment, the structure which provides the offset angles is a controller assembly 202 which is operatively coupled to the hand wheel actuator 46. The controller assembly 202 is a controller housing 204 which contains a controller for electrically interacting with the hand wheel actuator 46. The controller housing 202 defines an opening 206 which receives an end of the upper jacket 48 for coupling thereto. The opening 206 is defined by an inner wall which skews the longitudinal axis B of the upper jacket 48 from the central axis A of the hand wheel actuator 46. This is done by angling the opening's inner wall.

In any of the above-described embodiments, the angular skewing feature 102, 204 may provide an abrupt and/or extreme angle change to maximize collapse distance. In other embodiments, the feature 102, 204 provides a more subtle angle change for overall energy absorption and comfort. The angular skewing may be an intersection of two relative straight segments or may include curvature.

While the illustrated embodiments of FIGS. 2-5 are described in detail herein, it is to be appreciated that the angular bend feature may be integrally formed with the upper jacket 48, the motor output shaft disposed within the hand wheel actuator, the spindle, or another structure which is part of the upper portion of the steer-by-wire steering system in other embodiments. Alternatively, the angular bend feature may be a separate component which is implemented with added offset adaptor features and coupled to the steer-by-wire steering system, as disclosed herein.

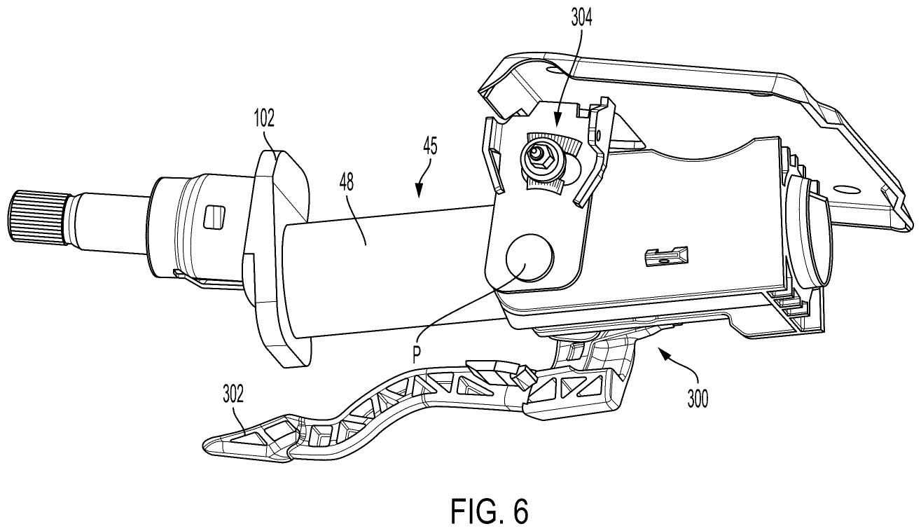

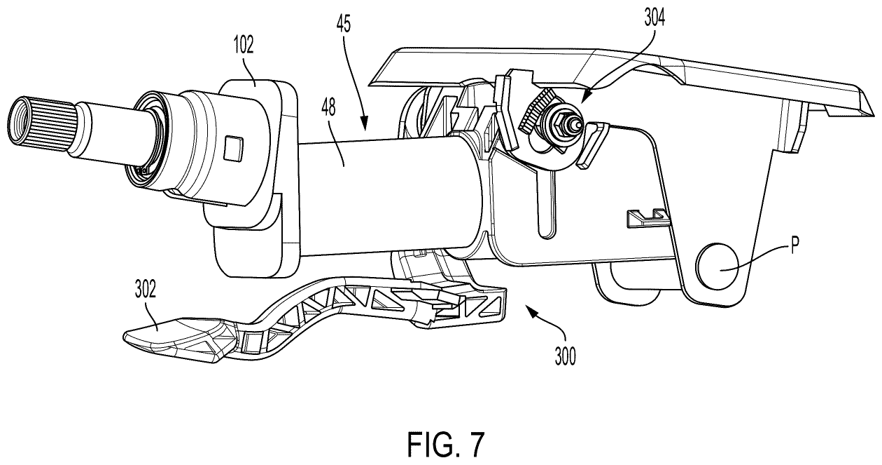

Referring now to FIGS. 6 and 7, features associated with a rake adjustment mechanism 300 are illustrated. For example, a lever 302 in a manual adjustment system and a locking assembly 304 are shown. The embodiments disclosed herein move components away from common locations not associated with a hand wheel actuator mounted adjacent to the steering wheel 42. This, with the angular skewing of the steering column 45 relative to the steering wheel 42, provides multiple options for a pivot location P about which the steering column 45 pivots for rake adjustment. It is to be appreciated that the pivot location P of the steering column 45 may be positioned above, below, forward or aft relative to the locking assembly 304 of the rake adjustment mechanism 300.

The embodiments disclosed herein maintain OEM steering wheel plane specifications, but skew the upper jacket to an angle that achieves additional collapse performance benefits due to the lower friction of the more horizontal column jacket.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in scope with the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

What is claimed is:

1. A vehicle steer-by-wire steering system comprising:
a column jacket; and
a hand wheel actuator operatively coupled to an end of the column jacket, the hand wheel actuator disposed between an end of the column jacket and a steering input device, wherein at least a portion of the column jacket extends about a longitudinal axis which is oriented at a non-parallel angle relative to a central axis of the hand wheel actuator.

2. The vehicle steer-by-wire steering system of claim 1, wherein the longitudinal axis of the column jacket is oriented closer to a horizontal angle relative to an angle defined by the central axis of the hand wheel actuator and the horizontal axis.

3. The vehicle steer-by-wire steering system of claim 2, further comprising an adaptor disposed between the end of the column jacket and the hand wheel actuator, wherein the adaptor is shaped to provide the non-parallel angle.

4. The vehicle steer-by-wire steering system of claim 3, wherein the adaptor is a motor controller housing.

5. The vehicle steer-by-wire steering system of claim 4, wherein the motor controller housing defines an opening with an inner wall which receives the column jacket.

6. The vehicle steer-by-wire steering system of claim 3, wherein the adaptor includes a first portion and a second portion, wherein the first portion is operatively coupled to the hand wheel actuator, wherein the second portion is operatively coupled to the column jacket.

7. The vehicle steer-by-wire steering system of claim 6, wherein the first portion is an extension of the second portion toward the hand wheel actuator.

8. The vehicle steer-by-wire steering system of claim 2, further comprising an angle skewing feature integrally formed on the end of the column jacket to define the non-parallel angle.

9. The vehicle steer-by-wire steering system of claim 3, wherein the adaptor is an angle skewing feature integrally formed on a spindle disposed within the hand wheel actuator.

10. The vehicle steer-by-wire steering system of claim 3, wherein the adaptor is an angle skewing feature integrally formed on a motor output shaft disposed within the hand wheel actuator.

11. A vehicle steer-by-wire steering system comprising:
a column jacket; and
a hand wheel actuator operatively coupled to an end of the column jacket, the hand wheel actuator disposed between an end of the column jacket and a steering input device, wherein at least a portion of the column jacket extends about a longitudinal axis which is not co-axial with a central axis of the hand wheel actuator.

12. The vehicle steer-by-wire steering system of claim 11, further comprising an adaptor disposed between the end of the column jacket and the hand wheel actuator, wherein the adaptor is shaped to provide the non-co-axial orientation of the column jacket and the hand wheel actuator.

13. The vehicle steer-by-wire steering system of claim 12, wherein the adaptor is a motor controller housing.

14. The vehicle steer-by-wire steering system of claim 13, wherein the motor controller housing defines an opening with an inner wall which receives the column jacket.

15. The vehicle steer-by-wire steering system of claim 12, wherein the adaptor includes a first portion and a second portion, wherein the first portion is operatively coupled to the hand wheel actuator, wherein the second portion is operatively coupled to the column jacket.

16. The vehicle steer-by-wire steering system of claim 15, wherein the first portion is an extension of the second portion toward the hand wheel actuator.

17. The vehicle steer-by-wire steering system of claim 11, further comprising an angle skewing feature integrally formed on the end of the column jacket to define the non-co-axial angle.

18. The vehicle steer-by-wire steering system of claim 11, wherein the longitudinal axis of the column jacket and the central axis of the hand wheel actuator are non-parallel with each other, wherein the longitudinal axis of the column jacket is oriented closer to a horizontal angle relative to an angle defined by the central axis of the hand wheel actuator and the horizontal axis.
